(19) United States
(12) Patent Application Publication
(10) Pub. No.: US 2014/0338376 A1
(43) Pub. Date: Nov. 20, 2014

(54) THERMAL MANAGEMENT SYSTEM FOR VEHICLE HAVING TRACTION MOTOR

(71) Applicant: Magna E-Car System of America, Inc., Auburn Hills, MI (US)

(72) Inventors: Neil Carpenter, Clarkston, MI (US); Guanging Gao, Rochester Hills, MI (US)

(21) Appl. No.: 14/368,977

(22) PCT Filed: Dec. 17, 2012
(86) PCT No.: PCT/US12/70084

§ 371 Date: Jun. 26, 2014

Related U.S. Application Data
(60) Provisional application No. 61/581,466, filed on Dec. 29, 2011.

(51) Int. Cl. B60H 1/00

(52) U.S. Cl. CPC B60H 1/00392; B60H 1/00278; B60H 2001/00307; B60H 2001/00942
USPC 62/115; 62/228.1

(57) ABSTRACT

A thermal management system for a vehicle includes a traction motor and a battery pack. The thermal management system comprises a battery circuit for cooling a battery circuit thermal load including the battery pack, a battery circuit temperature sensor positioned to sense a temperature relating to a temperature of the battery circuit thermal load, and a controller. The controller is configured to control the battery circuit to maintain the temperature sensed by the battery circuit temperature sensor below a first battery circuit temperature limit when the controller detects that the vehicle is not connected to an external electrical source, and to maintain the temperature sensed by the battery circuit temperature sensor below a second battery circuit temperature limit that is lower than the first battery circuit temperature limit when the controller detects that the vehicle is connected to the external electrical source.

### CROSS-REFERENCE TO RELATED APPLICATIONS

This application is a U.S. National Stage of International Application No. PCT/US2012/070084 filed Dec. 17, 2012 which claims priority to and the benefit of U.S. Provisional Application No. 61/581,466 filed Dec. 29, 2011. The entire disclosure of each of the above-noted applications is hereby incorporated by reference.

### FIELD

The present disclosure relates to vehicles that are powered at least partly by an electric motor and more particularly to battery electric vehicles with no internal combustion engine on board.

### BACKGROUND

This section provides background information related to the present disclosure which is not necessarily prior art.

Vehicles with traction motors offer the promise of powered transportation while producing few or no emissions at the vehicle. Such vehicles may be referred to as electric vehicles, however it will be noted that some electric vehicles include only an electric motor, while some electric vehicles include both a traction motor and an internal combustion engine. For example, some electric vehicles are powered by electric motors only and rely solely on the energy stored in an on-board battery pack. Some electric vehicles are hybrids, having both a traction motor and an internal combustion engine, which may, for example, be used to assist the traction motor in driving the wheels (a parallel hybrid), or which may, for example, be used solely to charge the on-board battery pack, thereby extending the operating range of the vehicle (a series hybrid). In some vehicles, there is a single, centrally-positioned electric motor that powers one or more of the vehicle wheels, and in other vehicles, one or more of the wheels have an electric motor (referred to sometimes as a hub motor) positioned at each driven wheel.

While currently proposed and existing vehicles are advantageous in some respects over internal-combustion engine powered vehicles, there are problems that are associated with some such vehicles. A particular problem is that their range is typically relatively short as compared to internal combustion engine-powered vehicles. This is particularly true for battery electric vehicles since they are not equipped with range extender engines. A reason for their typically relatively short range is the weight and cost of the battery packs used to store energy for the operation of such vehicles. It would be beneficial to provide technology that improves the efficiency with which power is used in the operation of the vehicle, so as to improve the range of such vehicles.

### SUMMARY

This section provides a general summary of the disclosure, and is not a comprehensive disclosure of its full scope of all of its features.

According to one aspect of this disclosure, a thermal management system for a vehicle is disclosed. The vehicle includes a traction motor and a battery pack. The thermal management system comprises a battery circuit for cooling a battery circuit thermal load including the battery pack, a battery circuit temperature sensor positioned to sense a temperature relating to a temperature of the battery circuit thermal load, and a controller. The controller is configured to control the battery circuit to maintain the temperature sensed by the battery circuit temperature sensor below a first battery circuit temperature limit when the controller detects that the vehicle is not connected to an external electrical source, and to maintain the temperature sensed by the battery circuit temperature sensor below a second battery circuit temperature limit that is lower than the first battery circuit temperature limit when the controller detects that the vehicle is connected to the external electrical source.

The system may further include a battery charge control module that controls electrical current sent to the battery pack from the external electrical source. The battery charge control module makes up part of the battery circuit thermal load.

The vehicle may further include a passenger cabin. The system may further include a first heat exchanger positioned to cool fluid in the battery circuit, a second heat exchanger positioned to cool an airflow leading to the passenger cabin, a compressor, positioned to compress refrigerant and to send the refrigerant through a refrigerant circuit leading to the first and second heat exchangers.

The first and second heat exchangers may be a chiller and an evaporator respectively.

The battery circuit can further include a valve positioned to connect the battery circuit to a motor circuit that includes a radiator.

The second temperature limit can be lower than the first temperature limit by between about 1 and about 3 degrees Celsius.

The thermal management system can further include a motor circuit for cooling a motor circuit thermal load including the traction motor, the motor circuit including a motor circuit pump. The thermal management system can further include a motor circuit temperature sensor positioned to sense a temperature of fluid in the motor circuit. The controller can be further configured to control the motor circuit to maintain the temperature sensed by the motor circuit temperature sensor below a first motor circuit temperature limit when detecting that the battery charge control module is not connected to the electrical source, and to control the motor circuit to maintain the temperature sensed by the motor circuit temperature sensor below a second motor circuit temperature limit that is higher than the third temperature limit when detecting that the battery charge control module is connected to the electrical source.

According to another aspect of this disclosure, an electric vehicle can include a passenger cabin, wheels coupled to the passenger cabin, a traction motor coupled to the wheels and configured to drive the wheels, a battery pack coupled to the traction motor and configured to provide electricity to the traction motor, and the thermal management system described above.

According to another aspect of this disclosure, a thermal management system for a vehicle is disclosed. The vehicle includes a traction motor, a battery, a battery charge control module, and a passenger cabin. The thermal management system includes a motor circuit for cooling a motor circuit thermal load including the traction motor, a motor circuit temperature sensor positioned to sense a temperature of fluid in the motor circuit, and a controller. The controller is configured to control the motor circuit to maintain the temperature sensed by the motor circuit temperature sensor below a first motor circuit temperature limit when the controller detects that the vehicle is not connected to an external electrical source, and to maintain the temperature sensed by the motor circuit temperature sensor below a second motor circuit temperature limit that is higher than the first motor circuit temperature limit when the controller detects that the vehicle is connected to an external electrical source.

According to a still further aspect of this disclosure, a method is provided of cooling a battery circuit thermal load for a battery circuit of a vehicle. The vehicle includes a traction motor and a battery pack that is at least part of the battery circuit thermal load. The method include the steps of cooling the battery circuit thermal load to maintain a temperature of the battery circuit thermal load below a first battery circuit temperature limit while not charging the battery pack using an external electrical source, and cooling the battery circuit thermal load to maintain the temperature of the battery circuit thermal load below a second battery circuit temperature limit, the second battery circuit temperature limit being lower than the first battery circuit temperature limit while charging the battery pack using an external electrical source.

In an embodiment, the vehicle includes a passenger cabin, a first heat exchanger positioned to cool fluid in the battery circuit, a second heat exchanger positioned to cool an airflow leading to the passenger cabin, and a compressor, positioned to compress refrigerant and to send the refrigerant through a refrigerant circuit leading to the first and second heat exchangers.

The first and second temperature limits can be selected based on performance of an evaporator of the electric vehicle.

The method can further include determining an ambient temperature to be above a threshold as a condition for cooling the battery to maintain the temperature of the battery below the second temperature limit.

The method can further include cooling a battery charge control module when cooling the battery.

The second temperature limit can be lower than the first temperature limit by between about 1 and about 3 degrees Celsius.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

The present disclosure will now be described, by way of example only, with reference to the attached drawings, in which:

FIG. 1 is a perspective view of an electric vehicle that includes a thermal management system in accordance with an embodiment of the present disclosure;

FIG. 2 is a schematic illustration of a thermal management system for the electric vehicle;

FIG. 3 is a graph of the temperature of battery packs that are part of the electric vehicle shown in FIG. 1;

FIG. 4 is a block diagram of a portion of the thermal management system showing components of the controller for cooling a battery using two temperature limits;

FIG. 5 is a flowchart of a method of cooling the battery using two temperature limits;

FIG. 6 is a chart showing battery and evaporator temperatures when charging and when driving;

FIG. 7 is a chart showing battery and evaporator temperatures when charging and when driving according to two temperature limits for the battery;

FIG. 8 is a block diagram of a portion of the thermal management system showing components of the controller for cooling the motor circuit using two temperature limits; and

FIG. 9 is a flowchart of a method of cooling the motor circuit using two temperature limits.

### DETAILED DESCRIPTION

Example embodiments will now be described more fully with reference to the accompanying drawings. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

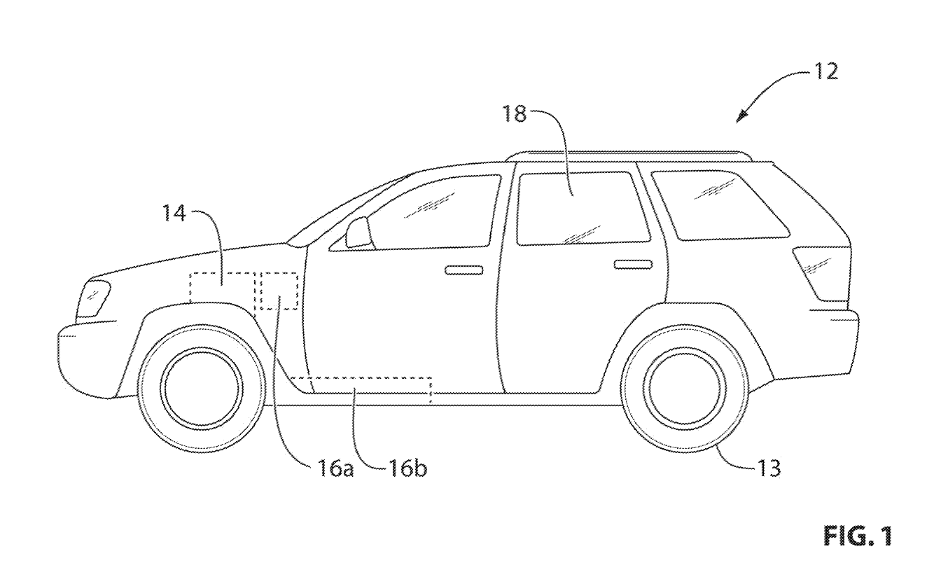

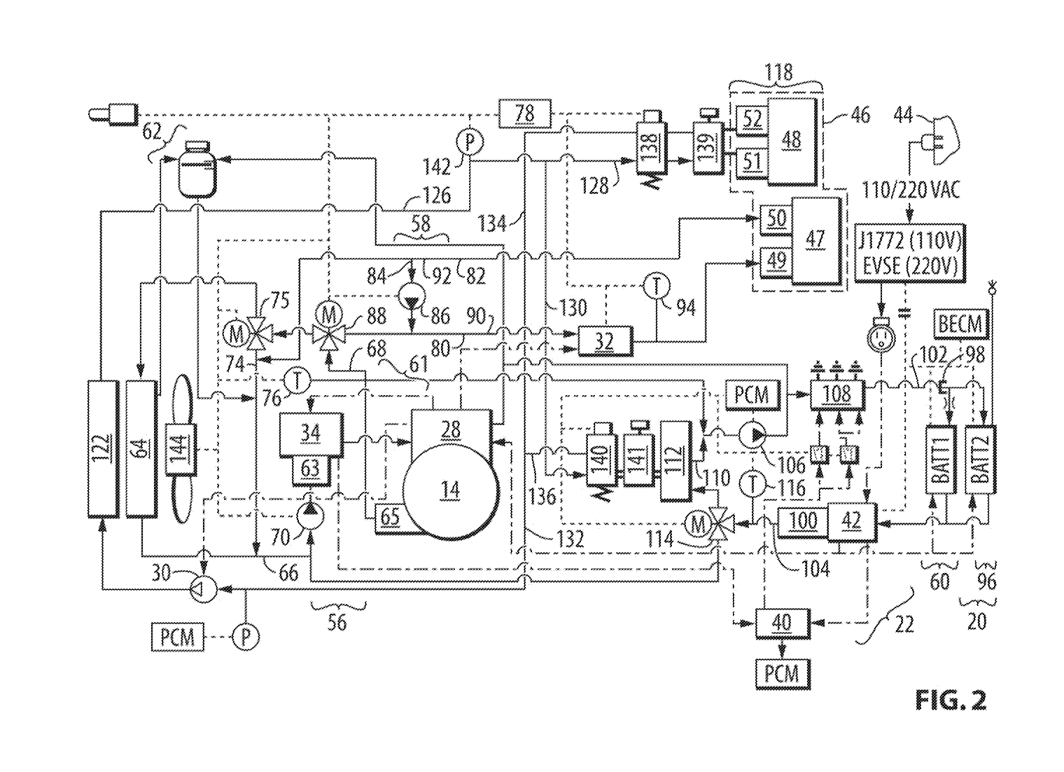

Reference is made to FIG. 2, which shows a schematic illustration of a thermal management system 10 for an electric vehicle 12 shown in FIG. 1. The electric vehicle 12 includes wheels 13, a traction motor 14 for driving the wheels 13, first and second battery packs 16a and 16b, a cabin 18, a high voltage electrical system 20 (FIG. 2) and a low voltage electrical system 22 (FIG. 2).

The motor 14 may have any suitable configuration for use in powering the electric vehicle 12. The motor 14 may be mounted in a motor compartment that is forward of the cabin 18 and that is generally in the same place an engine compartment is on a typical internal combustion powered vehicle. Referring to FIG. 2, the motor 14 generates heat during use and thus requires cooling. To this end, the motor 14 includes a motor coolant flow conduit for transporting coolant fluid about the motor 14 so as to maintain the motor within a suitable temperature range.

A transmission control system shown at 28 is part of the high voltage electrical system 20 and is provided for controlling the current flow to high voltage electrical loads within the vehicle 12, such as the motor 14, an air conditioning compressor 30, a heater 32 and a DC/DC converter 34. The transmission control system 28 generates heat during use and thus has a transmission control system coolant flow conduit associated therewith, for transporting coolant fluid about the transmission control system 28 so as to maintain the transmission control system 28 within a suitable temperature range. The transmission control system 28 may be positioned immediately upstream fluidically from the motor 14.

The DC/DC converter 34 receives current from the transmission control system 28 and converts the current from high voltage to low voltage. The DC/DC converter 34 sends the low voltage current to a low voltage battery shown at 40, which is used to power low voltage loads in the vehicle 12. The low voltage battery 40 may operate on any suitable voltage, such as 12 V.

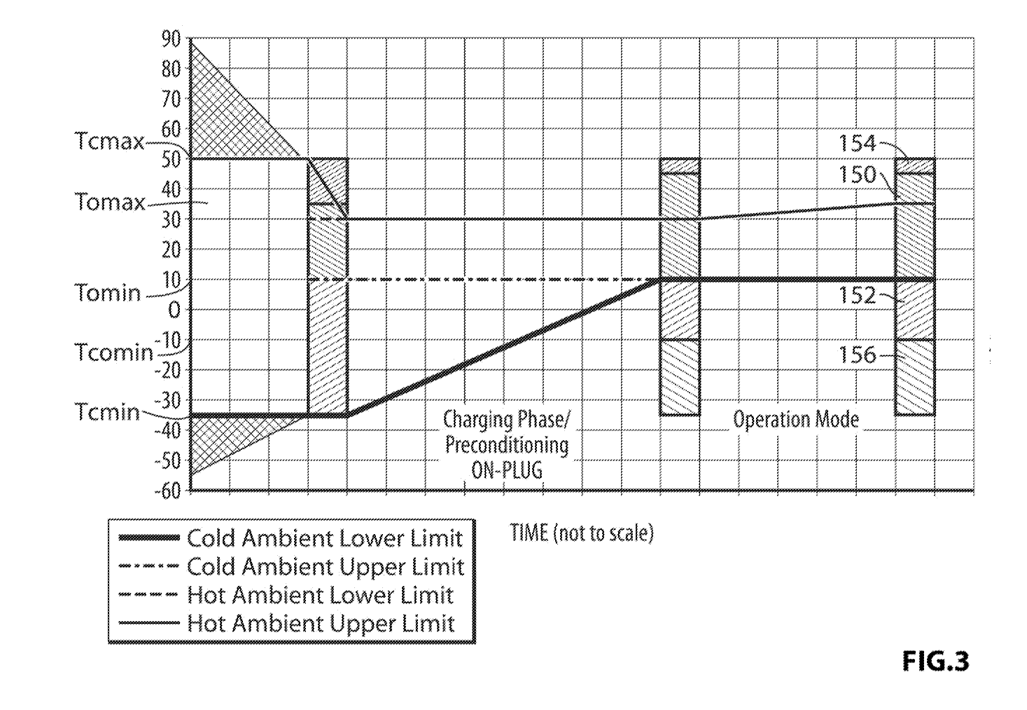

The battery packs 16a and 16b send power to the transmission control system 28 for use by the motor 14 and other high voltage loads and thus form part of the high voltage electrical system 20. The battery packs 16a and 16b may be any suitable types of battery packs. In an embodiment, the battery packs 16a and 16b are each made up of a plurality of lithium polymer cells. The battery packs 16a and 16b have a temperature range (shown in FIG. 3) in which the battery packs 16a and 16b may be maintained so as to provide a relatively long operating life. While two battery packs 16a and 16b are shown, it is alternatively possible to have any suitable number of battery packs, such as one battery pack, or three or more battery packs depending on the packaging constraints of the vehicle 12.

A battery charge control module shown at 42 is provided and is configured to connect the vehicle 12 to an electrical source (eg. a 110V source, or a 220V source) shown at 44, and to send the current received from the electrical source 44 to any of several destinations, such as, the battery packs 16a and 16b, the transmission control system 28 and the low voltage battery 40. The battery charge control module 42 generates heat during use and thus requires cooling. To this end, the battery charge control module 42 includes a battery charge control module fluid flow conduit for transporting fluid about the battery charge control module 42 from a battery charge control module inlet 4 to a battery charge control module outlet 26 so as to maintain the battery charge control module 42 within a suitable temperature range.

An HVAC system 46 is provided for controlling the temperature of the cabin 18 (FIG. 1). The HVAC system 46 is configured to be capable of both cooling and heating the cabin 18. To achieve this, the HVAC system 46 may include one or more heat exchangers, such as a cabin heating heat exchanger 47 and a cabin cooling heat exchanger 48 (which may be referred to as evaporator 48). The cabin heating heat exchanger 47 has a heat exchange fluid inlet 49 and a heat exchange fluid outlet 50 and is used to heat an air flow that is passed into the cabin 18. The cabin cooling heat exchanger 48 includes a refrigerant inlet 51 and a refrigerant outlet 52, and is used to cool an air flow that is passed into the cabin 18.

The motor 14, the transmission control system 28, the DC/DC converter 34, the battery packs 16a and 16b, the battery charge control module 42 and the HVAC system 46 constitute thermal loads on the thermal management system 10.

The thermal management system 10 includes a motor circuit 56, a cabin heating circuit 58, a battery circuit 60 and a main cooling circuit 62. The motor circuit 56 is configured for cooling the traction motor 14, the transmission control system 28 and the DC/DC converter 34, which constitute a motor circuit thermal load 61, which has a motor circuit thermal load inlet 63 and a motor circuit thermal load outlet 65. The motor circuit 56 includes a radiator 64, a first motor circuit conduit 66 fluidically between the radiator 64 to the motor circuit thermal load inlet 63, a second motor circuit conduit 68 fluidically between the motor circuit thermal load outlet 65 and the radiator 64, and a motor circuit pump 70 positioned to pump heat exchange fluid through the motor circuit 56.

Additionally a third motor circuit conduit 74 may be provided fluidically between the second and first motor circuit conduits 68 and 66 so as to permit the flow of heat exchange fluid to bypass the radiator 64 when possible (eg. when the heat exchange fluid is below a selected threshold temperature). To control whether the flow of heat exchange fluid is directed through the radiator 64 or through the third motor circuit conduit 74, a radiator bypass valve 75 is provided and may be positioned in the second motor circuit conduit 68. The radiator bypass valve 75 is controllable so that in a first position the valve 75 directs the flow of heat exchange fluid to the radiator 64 through the second motor circuit conduit 68 and in a second position the valve 75 directs the flow of heat exchange fluid to the first motor circuit conduit 66 through the third motor circuit conduit 74, so as to bypass the radiator 64. Flow through the third motor circuit conduit 74 is easier than flow through the radiator 64 (ie. there is less of a pressure drop associated with flow through the third conduit than there is with flow through the radiator 64) and so bypassing the radiator 64 whenever possible, reduces the energy consumption of the pump 70. By reducing the energy consumed by components in the vehicle 12 (FIG. 1), the range of the vehicle can be extended, which is particularly advantageous in electric vehicles.

It will be noted that only a single radiator bypass valve 75 is provided for bypassing the radiator 64. When the radiator bypass valve 75 is in the first position, all of the heat exchange fluid flow is directed through the second conduit 68, through the radiator 64 and through the first conduit 66. There is no net flow through the third conduit 74 because there is no net flow into the third conduit. Conversely, when the radiator bypass valve 75 is in the second position, all of the heat exchange fluid flow is directed through the third conduit 74 and back to the first conduit 66. There is no net flow through the radiator 64 because there is no net flow into the radiator 64. Thus, using only a single valve (ie. the bypass valve 75) provides the capability of selectably bypassing the radiator 64, instead of using one valve at the junction of the second and third conduits 68 and 74 and another valve at the junction of the first and third conduits 66 and 74. As a result of using one valve (ie. valve 75) instead of two valves, the motor circuit 56 contains fewer components, thereby making the thermal management system 10 less expensive, simpler to make and to operate and more reliable. Furthermore by eliminating one valve, the energy required to move the heat exchange fluid through the motor circuit 56 is reduced, thereby reducing the energy consumed by the pump 70 and extending the range of the vehicle 12 (FIG. 1).

The pump 70 may be positioned anywhere suitable, such as in the first motor circuit conduit 66.

The elements that make up the motor circuit thermal load may be arranged in any suitable way. For example, the DC/DC converter 34 may be downstream from the pump 70 and upstream from the transmission control system 28, and the motor 14 may be downstream from the transmission control system 28. Thus, the inlet to the DC/DC converter 34 constitutes the thermal load inlet 63 and the motor outlet constitutes the thermal load outlet 65.

A motor circuit temperature sensor 76 is provided for determining the temperature of heat exchange fluid at a selected point in the motor circuit 56. As an example, the motor circuit temperature sensor 76 may be positioned downstream from all the thermal loads in the motor circuit 56, so as to record the highest temperature of the heat exchange fluid. Based on this temperature, a controller, shown at 78 can determine whether or not to position the radiator bypass valve 75 in a first position wherein the radiator bypass valve 75 transfers the flow of heat exchange fluid towards the radiator 64 and a second position wherein the radiator bypass valve 75 bypasses the radiator 64 and transfers the flow of heat exchange fluid through the third motor circuit conduit 74 back to the first motor circuit conduit 66.

The cabin heating circuit 58 is configured for providing heated heat exchange fluid to the HVAC system 46 and more specifically to the cabin heating heat exchanger 47, which constitutes the cabin heating circuit thermal load. The cabin heating circuit 58 includes a first cabin heating circuit conduit 80 fluidically between the second motor circuit conduit 68 and the cabin heating heat exchanger inlet 49 (which in the embodiment shown is the inlet to the cabin heating circuit thermal load), a second cabin heating circuit conduit 82 fluidically between the cabin heating circuit heat exchanger outlet 50 (which in the embodiment shown is the outlet from the cabin heating circuit thermal load) to the motor circuit 56. In the embodiment shown the second cabin heating circuit conduit 82 extends to the third motor circuit conduit 74. This is because the cabin heating heat exchanger 47 serves to cool the heat exchange fluid by some amount, so that the resulting cooled heat exchange fluid need not be passed through the radiator 64 in the motor circuit 56. By reducing the volume of heat exchange fluid that passes through the radiator 64, energy consumed by the pump 70 is reduced, thereby extending the range of the vehicle 12 (FIG. 1). In an alternative embodiment, the second cabin heating circuit conduit 82 may extend to the second motor circuit conduit 68 downstream so that the heat exchange fluid contained in the second cabin heating circuit conduit 82 passes through the radiator 64.

In some situations the heat exchange fluid will not be sufficiently hot to meet the demands of the HVAC system 46. For such situations, the heater 32 which may be referred to as the cabin heating circuit heater 32 is provided in the first cabin heating circuit conduit 80. The cabin heating circuit heater 32 may be any suitable type of heater, such as an electric heater that is one of the high voltage electrical components fed by the transmission control system 28.

A third cabin heating circuit conduit 84 may be provided between the second and first cabin heating circuit conduits 82 and 80. A cabin heating circuit pump 86 is provided in the third conduit 84. In some situations it will be desirable to circulate heat exchange fluid through the cabin heating circuit 58 and not to transfer the fluid back to the motor circuit 56. For example, when the fluid is being heated by the heater 32 it may be advantageous to not transfer the fluid back to the motor circuit 56 since the fluid in the motor circuit 56 is used solely for cooling the thermal load 61 and it is thus undesirable to introduce hot fluid into such a circuit. For the purpose of preventing fluid from being transferred from the cabin heating circuit 58 back to the motor circuit 56, a cabin heating circuit valve 88 is provided. In the embodiment shown, the cabin heating circuit valve 88 is positioned in the second motor circuit conduit 68 and is positionable in a first position wherein the valve 88 directs fluid flow towards the radiator 64 through the second motor circuit conduit 68, and a second position wherein the valve 88 directs fluid flow towards the cabin heater heat exchanger 47 through the first cabin heating circuit conduit 80.

When the cabin heating circuit valve 88 is in the second position, the pump 86 may operate at a selected, low, flow rate to prevent the fluid flow from short circuiting the cabin heating circuit by flowing up the third conduit 84.

It will be noted that separation of the fluid flow through the cabin heating circuit 58 and the motor circuit 56 is achieved using a single valve (ie.

valve 88) which is positioned at the junction of the second motor circuit conduit 68 and the first cabin heating circuit conduit 80. When the valve 88 is positioned in the first position, fluid is directed towards the radiator 64. There is no net flow out of the cabin heating circuit 58 since there is no flow into the cabin heating circuit 58. When the valve 88 is positioned in the second position and the pump 86 is off, fluid is directed through the cabin heating circuit 58 and back into the motor circuit 56. When the valve 88 is positioned in the first position and the pump 86 is on, there is no net flow out of the second cabin heating circuit conduit 82 as noted above, however, the pump 86 generates a fluid circuit loop and drives fluid in a downstream portion 90 of the first cabin heating circuit conduit 80, through the cabin heating heat exchanger 47, and through an upstream portion 92 of the second cabin heating circuit conduit 82, whereupon the fluid is drawn back into the pump 86. Because this feature is provided using a single valve (ie. valve 88), as opposed to using one valve at the junction of the first cabin heating circuit conduit 80 and the motor circuit 56 and another valve at the junction of the second cabin heating circuit conduit 82 and the motor circuit 56, the thermal management system 10 is made simpler and less expensive, and energy consumption is reduced by having fewer valves in the system 10 so as to reduce the energy required by the pump 70 to pump liquid through such valves.

Additionally, the valve 88 combined with the pump 86 permit isolating heated fluid in the cabin heating circuit 58 from the fluid in the motor circuit 56, thereby preventing fluid that has been heated in the cabin heating circuit heater 32 from being sent to the radiator 64 to be cooled.

A cabin heating circuit temperature sensor 94 may be provided for determining the temperature of the fluid in the cabin heating circuit 58. The temperature sensor 94 may be positioned anywhere suitable, such as downstream from the cabin heating circuit heater 32. The temperature sensor 94 may communicate with the controller 78 so that the controller 78 can determine whether or not to carry out certain actions. For example, using the temperature sensed by the temperature sensor 94, the controller 78 can determine whether the heater 32 should be activated to meet the cabin heating demands of the HVAC system 46.

The battery circuit 60 is configured for controlling the temperature of the battery packs 16a and 16b and the battery charge control module 42, which together make up the battery circuit thermal load 96. A thermal load inlet is shown at 98 upstream from the battery packs 16a and 16b and a thermal load outlet is shown at 100 downstream from the battery charge control module 42.

The battery packs 16a and 16b are in parallel in the battery circuit 60, which permits the fluid flow to each of the battery packs 16a and 16b to be selected individually so that each battery pack 16a or 16b receives as much fluid as necessary to achieve a selected temperature change. A valve for adjusting the flow of fluid that goes to each battery pack 16a and 16b during use of the thermal management system 10 may be provided, so that the fluid flow can be adjusted to meet the instantaneous demands of the battery packs 16a and 16b. After the fluid has passed through the battery packs 16a and 16b, the fluid is brought into a single conduit which passes through the battery charge control module 42. While the battery packs 16a and 16b are shown in parallel in the battery circuit 60, they could be provided in series in an alternative embodiment.

A first battery circuit conduit 102 extends between the second motor circuit conduit 68 and the battery circuit thermal load inlet 98. A second battery circuit conduit 104 extends between the thermal load outlet 100 and the first motor circuit conduit 66. A battery circuit pump 106 may be provided for pumping fluid through the battery circuit 60 in situations where the battery circuit 60 is isolated from the motor circuit 56. A battery circuit heater 108 is provided in the first conduit 102 for heating fluid upstream from the thermal load 96 in situations where the thermal load 96 requires heating. The battery circuit heater 108 may operate on current from a low voltage current source, such as the low voltage battery 40. This is discussed in further detail further below.

A third battery circuit conduit 110 may be provided fluidically between the second and first battery circuit conduits 102 and 104 so as to permit the flow of heat exchange fluid in the battery circuit 60 to be isolated from the flow of heat exchange fluid in the motor circuit 56. A chiller 112 may be provided in the third conduit 110 for cooling fluid upstream from the thermal load 96 when needed.

A battery circuit valve 114 is provided in the second conduit 104 and is positionable in a first position wherein the flow of fluid is directed towards the first motor circuit conduit 66 and in a second position wherein the flow of fluid is directed into the third battery circuit conduit 110 towards the first battery circuit conduit 102.

It will be noted that the flow in the battery circuit 60 is isolated from the flow in the motor circuit 56 with only one valve (ie. valve 114). When the valve 114 is in the second position so as to direct fluid flow through the third conduit 110 into the first conduit 102, there is effectively no flow from the first motor circuit 56 through the first conduit 102 since the loop made up of the downstream portion of the first conduit 102, the thermal load 96, the second conduit 104 and the third conduit 110 is already full of fluid. By using only one valve (ie. valve 114) to isolate the battery circuit 60, the amount of energy consumed by the pump 106 to pump fluid around the battery circuit 60 is reduced relative to a similar arrangement using two valves. Additionally, by using only one valve the battery circuit 60 has fewer components and is thus simpler, which can result in reduced cost and increased reliability for the therman management system 10.

A battery circuit temperature sensor 116 is provided for sensing the temperature of the fluid in the battery circuit 60. The temperature sensor 116 may be positioned anywhere in the battery circuit 60, such as in the second conduit 104 downstream from the thermal load 96. The temperature from the temperature sensor 116 can be sent to the controller 78 to determine whether to have the valve 114 should be in the first or second position and whether any devices (eg. the chiller 112, the heater 108) need to be operated to adjust the temperature of the fluid in the first conduit 102.

The main cooling circuit 62 is provided for assisting in the thermal management of the thermal loads in the HVAC system 46 and the battery circuit 60. More particularly, the thermal load in the HVAC system 46 is shown at 118 and is made up of the cabin cooling heat exchanger 48 (ie. the evaporator 48).

The components of the main cooling circuit 62 that are involved in the cooling and management of the refrigerant flowing therein include the compressor 30 and a condenser 122. A first cooling circuit conduit 126 extends from the condenser 122 to a point wherein the conduit 126 divides into a first branch 128 which leads to the HVAC system 46 and a second branch 130 which leads to the battery circuit 60. A second cooling circuit conduit 132 has a first branch 134 that extends from the HVAC system 46 to a joining point and a second branch 136 that extends from the battery circuit 60 to the joining point. From the joining point, the second cooling circuit conduit 132 extends to the inlet to the compressor 30.

At the downstream end of the first branch 128 of the first conduit 126 is a flow control valve 138 which controls the flow of refrigerant into the cabin cooling heat exchanger 48. The upstream end of the first branch 134 of the second conduit 132 is connected to the refrigerant outlet from the heat exchanger 48. It will be understood that the valve 138 could be positioned at the upstream end of the first branch 134 of the second conduit 132 instead. The valve 138 is controlled by the controller 78 and is opened when refrigerant flow is needed through the heat exchanger 48.

At the downstream end of the second branch 130 of the first conduit 126 is a flow control valve 140 which controls the flow of refrigerant into the battery circuit chiller 112. The upstream end of the second branch 136 of the second conduit 132 is connected to the refrigerant outlet from the chiller 112. It will be understood that the valve 140 could be positioned at the upstream end of the second branch 136 of the second conduit 132 instead. The valve 140 is controlled by the controller 78 and is opened when refrigerant flow is needed through the chiller 112.

The valves 138 and 140 may be any suitable type of valves with any suitable type of actuator. For example, they may be solenoid actuated/spring return valves. Additionally thermostatic expansion valves shown at 139 and 141 may be provided downstream from the valves 138 and 140.

A refrigerant pressure sensor 142 may be provided anywhere suitable in the cooling circuit 62, such as on the first conduit 126 upstream from where the conduit 126 divides into the first and second branches 128 and 130.

The pressure sensor 142 communicates pressure information from the cooling circuit 62 to the controller 78.

A fan shown at 144 is provided for blowing air on the radiator 64 and the condenser 122 to assist in cooling and condensing the heat exchange fluid and the refrigerant respectively. The fan 144 is controlled by the controller 78.

An expansion tank 124 is provided for removing gas that can accumulate in other components such as the radiator 64. The expansion tank 124 may be positioned at the highest elevation of any fluid-carrying components of the thermal management system. The expansion tank 124 may be used as a point of entry for heat exchange fluid into the thermal management system 10 (ie. the system 10 may be filled with the fluid via the expansion tank 124).

The controller 78 is described functionally as a single unit, however the controller 78 may be made up of a plurality of units that communicate with each other and which each control one or more components of the thermal management system 10, as well as other components optionally.

The logic used by the controller 78 to control the operation of the thermal management system 10 depends on which of several states the vehicle is in. The vehicle may be on-plug and off, which means that the vehicle itself is off (eg. the ignition key is out of the ignition slot in the instrument panel) and is plugged into an external electrical source (eg. for recharging the battery packs 16a and 16b). The vehicle may be off-plug and off, which means that the vehicle itself is off and is not plugged into an external electrical source. The vehicle may be off-plug and on, which means that the vehicle itself is on and is not plugged into an external electrical source. The logic used by the controller 78 may be as follows:

The controller 78 attends to the cooling requirements of the thermal load 61 of the motor circuit 56 when the vehicle is off-plug and when the vehicle is on. The controller 78 determines a maximum permissible temperature (e.g., 50 degrees Celsius) for the heat exchange fluid and determines if the actual temperature of the heat exchange fluid exceeds the maximum permissible temperature (based on the temperature sensed by the temperature sensor 76) by more than a selected amount (which is a calibrated value, and which could be 0 for example). If so, the controller operates the pump 70 to circulate the heat exchange fluid through the motor circuit 56 until a lower temperature is sensed at the temperature sensor 76 (e.g., 46 degrees Celsius). Initially when the vehicle enters the state of being off-plug and on, the controller 78 may default to a ‘cooling off’ mode wherein the pump 70 is not turned on, until the controller 78 has determined and compared the aforementioned temperature values. In the event that the vehicle is in a fault state, the controller 78 may enter a motor circuit cooling fault mode. When the controller 78 exits the fault state, the controller 78 may pass to the ‘cooling off’ mode.

The controller 78 attends to the heating and cooling requirements of the cabin heating circuit 58 when the vehicle is on-plug and when the vehicle is off-plug and on. The controller 78 may have 3 cabin heating modes. The controller 78 determines if the requested cabin temperature from the climate control system in the cabin 18 exceeds the temperature sensed by a temperature sensor in the evaporator 48 that senses the actual temperature in the cabin 18 by a selected calibrated amount. If so, and if the vehicle is either off plug and on or on plug and there is sufficient power available from the electrical source, and if the controller 78 determines if the temperature sensed by the temperature sensor 76 is higher than the requested cabin temperature by a selected calibrated amount. If the temperature sensed by the temperature sensor 76 is higher, then the controller 78 positions the cabin heating circuit valve 88 in the second position wherein flow is generated through the cabin heating circuit 58 from the motor circuit 56 and the controller 78 puts the cabin heating circuit heater 32 in the off position. These settings make up the first cabin heating mode. If the temperature sensed by the temperature sensor 76 is lower than the requested cabin temperature by a selected calibrated amount, then the controller 78 positions the cabin heating circuit valve 88 in the first position and turns on the pump 86 so that flow in the cabin heating circuit 58 is isolated from flow in the motor circuit 56, and the controller 78 additionally turns on the cabin heating circuit heater 32 to heat the flow in the cabin heating circuit 58. These settings make up the second cabin heating mode.

If the temperature sensed by the temperature sensor 76 is within a selected range of the requested temperature from the climate control system then the controller 78 positions the cabin heating circuit valve 88 in the second position so that flow in the cabin heating circuit 58 is not isolated from flow in the motor circuit 56, and the controller turns the heater 32 on. These settings make up the third cabin heating mode. The selected range may be the requested temperature from the climate control system minus the selected calibrated value, to the requested temperature from the climate control system plus the selected calibrated value.

The default state for the controller 78 when cabin heating is initially requested may be to use the first cabin heating mode.

The controller 78 may have one cabin cooling mode. The controller 78 determines if the actual temperature of the evaporator 48 is higher than the target temperature of the evaporator 48 by more than a calibrated amount. If so, and if the vehicle is either off plug and on or on plug and there is sufficient power available from the electrical source, then the controller 78 turns on the compressor 30 and moves the refrigerant flow control valve 138 to the open position so that refrigerant flows through the cabin cooling heat exchanger 48 to cool an air flow that is passed into the cabin 18.

The thermal management system 10 will enter a cabin heating and cabin cooling fault mode when the vehicle is in a fault state.

When the climate control system in the cabin 18 is set to a ‘defrost’ setting, the controller 78 will enter a defrost mode, and will return to whichever heating or cooling mode the controller 78 was in once defrost is no longer needed.

The default mode for the controller 78 with respect to the cabin heating circuit 58 may be to have the cabin heating circuit valve 88 in the first position to direct flow towards the radiator, and to have the heater 32 off, the pump 86 off. The default mode for the controller 78 with respect to cooling the cabin 18 may to be to have the refrigerant flow control valve 138 in the closed position to prevent refrigerant flow through the cabin cooling heat exchanger 48, and to have the compressor 30 off.

The controller 78 attends to the heating and cooling requirements of the battery circuit 60 when the vehicle is on-plug and is off, and when the vehicle is off-plug and is on. The controller 78 may have three cooling modes for cooling the battery circuit thermal load 96. The controller 78 determines a desired battery pack temperature based on the particular situation, and determines if a first cooling condition is met, which is whether the desired battery pack temperature is lower than the actual battery pack temperature by a first selected calibrated amount.

If the first cooling condition is met, the controller 78 determines which of the three cooling modes the controller 78 will operate in by determining which, if any, of the following second and third cooling conditions are met.

The second condition is whether the temperature sensed by the temperature sensor 76 is lower than the desired battery pack temperature by at least a second selected calibrated amount DT2, which may, for example, be related to the expected temperature rise that would be incurred in the flow of fluid from the temperature sensor 76 to the battery circuit thermal load 96. If the second condition is met, then the controller 78 operates in a first battery circuit cooling mode, wherein the controller 78 positions the battery circuit valve 114 in the first position wherein flow is generated through the battery circuit 60 from the motor circuit 56 and the controller 78 puts the refrigerant flow control valve 140 in the closed position preventing refrigerant flow through the chiller 112. The first battery circuit cooling mode thus uses the radiator 68 to cool the battery circuit thermal load 96 via the motor circuit 56.

The third cooling condition is whether the temperature sensed by the temperature sensor 76 is greater than the desired battery pack temperature by at least a third selected calibrated amount DT3, which may, for example, be related to the expected temperature drop associated with the chiller 112. If the third cooling condition is met, then the controller 78 operates in a second battery circuit cooling mode wherein the controller 78 positions the battery circuit valve 114 in the second position and turns on the pump 106 so that flow in the battery circuit 60 is isolated from flow in the motor circuit 56, and the controller 78 additionally positions the flow control valve 140 in the open position so that refrigerant flows through the chiller 112 to cool the flow in the battery circuit 60.

If neither the second or third cooling conditions are met, (ie. if the temperature sensed by the temperature sensor 76 is greater than or equal to the desired battery pack temperature minus the second selected calibrated amount DT2 and the temperature sensed by the temperature sensor 76 is less than or equal to the desired battery pack temperature plus the third selected calibrated amount DT3, then the controller 78 operates in a third battery circuit cooling mode wherein the controller 78 positions the battery circuit valve 114 in the first position so that flow in the battery circuit 60 is not isolated from flow in the motor circuit 56, and the controller 78 turns the chiller 112 on.

It will be understood that in any of the battery circuit cooling modes, the controller 78 turns the battery circuit heater 108 off.

The battery packs 16a, 16b can be cooled according to more than one upper temperature limit. For instance, when the vehicle 12 is on-plug and charging, the upper temperature limit can be set lower than when the vehicle 12 if off-plug and being operated. This is so that if the vehicle 12 is taken off plug when the battery temperature is at or near the on-plug upper temperature limit and cabin cooling is demanded from the HVAC system 46 at the same time, then the battery temperature is allowed to warm to the higher off-plug temperature limit so as to avoid both the battery chiller 112 and the cabin cooling heat exchanger (evaporator) 48 from demanding and competing for cooling from the compressor 30. When the evaporator 48 and the chiller 112 compete for refrigerant from the compressor 30 it increases the amount of time needed for the HVAC system 46 to cool the cabin 18 down to a requested temperature. Furthermore, in at least some embodiments, the system could be configured to preferentially send refrigerant to the battery chiller 112 in the event that both the chiller 112 and the evaporator 48 were competing for refrigerant. This is because it may be considered more critical to ensure that the battery packs 16a and 16b remain at a temperature that avoids damage to them than it is to keep the vehicle occupants comfortable. This problem may be aggravated in hot climates, and/or if the cabin air control is set to intake a significant amount of fresh air, (as opposed to recirculating all or most cabin air).

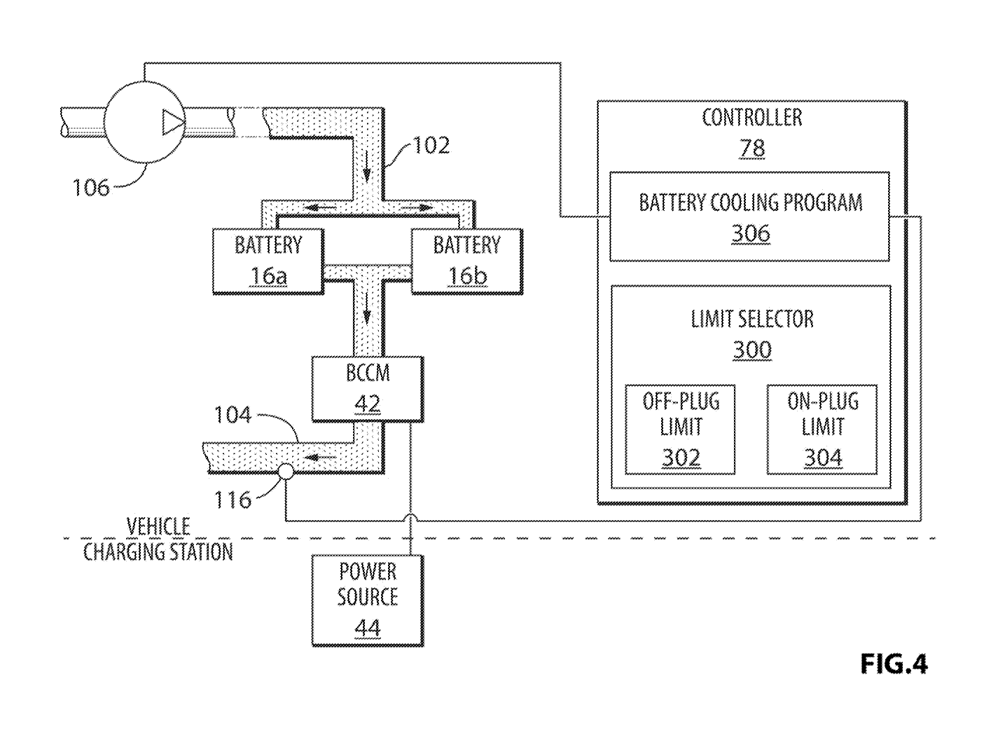

FIG. 4 shows a portion of the battery circuit 60 including the battery circuit pump 106, the battery circuit conduits 102, 104, the battery circuit temperature sensor 116, as well as the battery packs 16a, 16b and the battery charge control module 42. Heat exchange fluid flow is indicated by the arrows. Some components of the battery circuit 60 are omitted from this FIG. for clarity.

As mentioned, the external electrical power source 44 is for charging the battery packs 16a, 16b. The electrical source 44 can be provided at a charging station and can include an electrical plug that removably connects to the battery charge control module 42. The electrical source 44 is shown in the FIG. as electrically connected to the battery charge control module 42.

Also shown in FIG. 4 is the controller 78 as well as several functional components of the controller 78. For clarity, not all components of the controller 78 are shown. The controller 78 is configured to detect when the battery charge control module 42 is connected to the electrical source 44 to charge the battery packs 16a, 16b. In this example, the controller 78 includes a limit selector 300 electrically connected to the battery charge control module 42. The limit selector 300 can be part of the hardware or software that controls operation of the battery charge control module 42. The limit selector 300 can include hardware (such as a logic circuit) and/or software (such as a processor-executable code). The limit selector 300 can be part of a larger control program of the thermal management system 10.

The limit selector 300 selects a temperature limit for the battery circuit temperature sensor 116 with reference to whether the battery charge control module 42 is detected as connected to the electrical source 44. The limit selector 300 selects a first battery circuit temperature limit (off-plug limit) 302 for use when the battery charge control module 42 is not connected to the electrical source 44 and selects a second battery circuit temperature limit (on-plug limit) 304 for use when the battery charge control module 42 is connected to the electrical source 44. The second temperature limit 304 is lower than the first temperature limit 302.

The first and second temperature limits 302, 304 are upper limits, or maximum temperatures, that the controller 78 will allow at the battery circuit temperature sensor 116 before cooling the battery packs 16a, 16b, (e.g. using one of the methods discussed above). The first and second temperature limits 302, 304 can be the upper limits of temperature ranges that also have lower limits for the controller 78 to reference to stop cooling the battery packs 16a, 16b. In this example, the first temperature limit 302 is 38 degrees Celsius and is the upper limit of a temperature range that has a lower limit of 36 degrees Celsius, and the second temperature limit 304 is 37 degrees Celsius and is the upper limit of another temperature range that has a lower limit of 35 degrees Celsius. Thus, the second temperature limit is lower than the first temperature limit by 1 degree Celsius. In other examples, the second temperature limit is lower than the first temperature limit by between about 1 and about 3 degrees Celsius. The first and second temperature limits 302, 304 can be selected based on performance of an evaporator 48, as well as other components, such as the compressor 30. That is, if the evaporator 48 is capable of cooling the passenger cabin 18 relatively quickly, then a smaller difference (e.g., 1 degree Celsius) between the first and second temperature limits 302, 304 can be selected, which corresponds to a shorter delay for cooling the battery packs 16a, 16b. If the evaporator 48 requires more time to cool the cabin 18, then a larger difference (e.g., 3 degrees Celsius) between the first and second temperature limits 302, 304 can be selected, reflecting a longer delay for cooling the battery packs 16a, 16b.

It will be noted that it is theoretically possible to set the on-plug upper temperature limit (i.e. the second temperature limit) to be much lower than the off-plug upper temperature limit (i.e. the first temperature limit) in order to maximize the amount of delay that would be possible before having to cool the battery packs 16a and 16b when the vehicle is taken off-plug. This would potentially negatively impact the vehicle's MPGe rating, however, which takes into account the amount of energy consumed by the vehicle while on-plug, among other things. Accordingly, a smaller difference between the on-plug and off-plug upper temperature limits may be provided thereby making for a smaller available delay so as to improve the MPGe rating for the vehicle. A difference of about 1 to about 3 degrees Celsius has been found to be acceptable for most climates in the sense that such a difference permits a vehicle occupant to pull down the cabin temperature by an acceptable amount before the battery packs 16a and 16b demand cooling via the refrigerant system while keeping the overall on-plug energy consumption relatively low so as to keep any negative impact to the MPGe rating for the vehicle relatively low.

The controller 78 is configured to operate the battery circuit 60 to conform to the selected temperature limit 302 or 304 for the battery circuit temperature sensor 116. As previously discussed with respect to the battery circuit cooling modes, the controller 78 can operate or refrain from operating any of the fluid-circuit components of the battery circuit 60 and the motor circuit 56, including the pump 106, valve 114, chiller 112, chiller flow valve 140, compressor 30, and radiator fan 144, to cool the battery circuit 60. A battery circuit cooling program 306 can be included in the controller 78 to ensure that the temperature of the battery circuit 60 as measured by the battery circuit temperature sensor 116 remains about below the temperature limit 302 or 304 selected by the limit selector 300.

The battery circuit cooling program 306 can include hardware or software components, such as a logic circuit, an RLC circuit, and processor-executable code. In this example, the battery circuit cooling program 306 is a program executed by a processor of the controller 78. Such a program can include one or more of a standalone executable program, a subroutine, a function, a module, a class, an object, or another programmatic entity. The battery circuit cooling program 306 can be part of a larger control program of the thermal management system 10. The battery circuit cooling program 306 can include logic of the limit selector 300. The battery circuit cooling program 306 has available as input the temperature sensed by the battery circuit temperature sensor 116, and can output a commanded speed for the battery circuit pump 106, as well as a control command for the chiller 112, such as a position of the flow control valve 140 and/or a requested capacity from the compressor 30. The battery circuit cooling program 306 can have additional inputs and outputs as well.

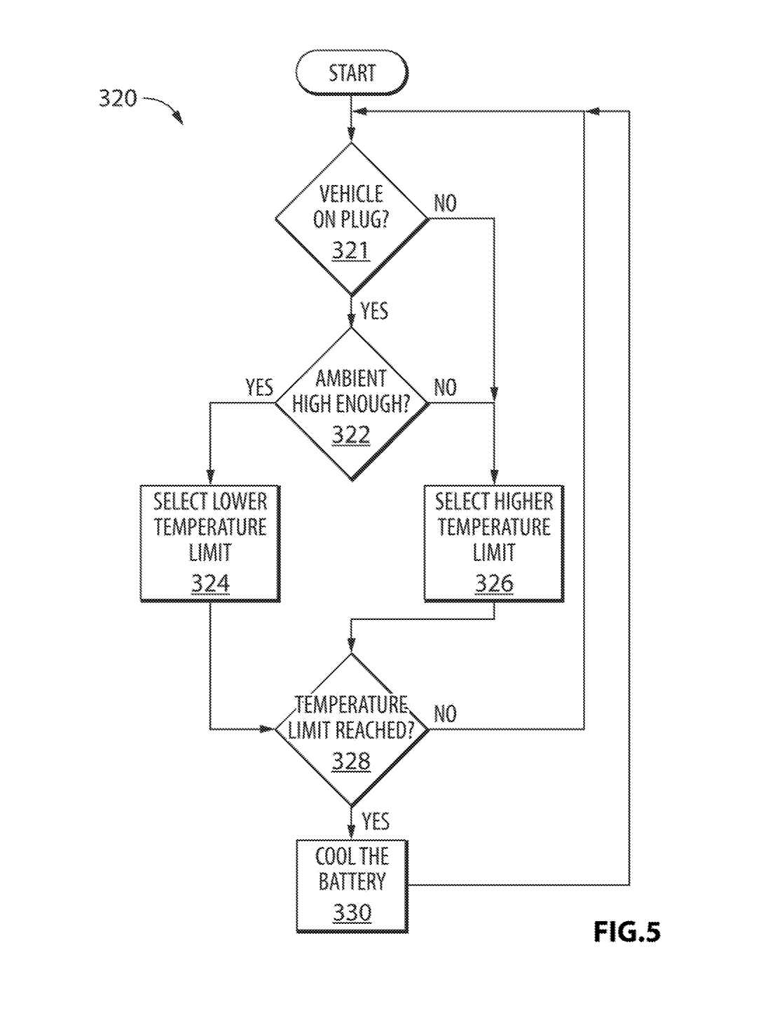

FIG. 5 shows a method 320 that can be performed by the controller 78, and specifically, by the limit selector 300 and the battery circuit cooling program 306. The method 320 can cool the battery according to two different temperature limits.

At 321, it is determined whether the vehicle 12 is on-plug and the battery packs 16a, 16b are being charged. This can be determined by the limit selector 300.

At 322, if the vehicle 12 is on-plug, the ambient temperature can be sensed and it can be determined whether the ambient temperature is high enough to expect demand on the compressor 30 for cabin cooling when the vehicle 12 is taken off plug. The controller 78 can compare the temperature sensed by the ambient temperature sensor 180 to a threshold, such as 21 degrees Celsius.

When the vehicle 12 is on-plug and the battery packs 16a, 16b are being charged and, optionally, the ambient temperature is higher than the threshold, the second, lower temperature limit 304 is selected, at 324. Continuing the above example, the limit selector 300 selects 37 degrees Celsius as the temperature limit.

When the vehicle 12 is off-plug and the battery packs 16a, 16b are being discharged to operate the vehicle 12, the first, higher temperature limit 302 is selected, at 326. Continuing the above example, the limit selector 300 selects 38 degrees Celsius as the temperature limit. Since the passenger cabin 18 may also be undergoing cooling via the evaporator 48 at this time, selection of the higher temperature limit of 38 degrees Celsius means that cooling of the battery will be delayed to allow for full cooling capacity to reach the passenger cabin 18, in case the vehicle 12 was taken off plug at or near the on-plug limit of 37 degrees Celsius.

At 328, it is then determined whether the battery packs 16a, 16b have reached the selected temperature limit. The battery circuit cooling program 306 compares the temperature of the battery circuit temperature sensor 116 to the selected temperature limit. If the selected temperature limit has not been reached, then the method 320 loops back to 321.

If the selected temperature limit has been reached, then the battery packs 16a, 16b are cooled, at 330. The battery circuit cooling program 306 operates the battery circuit 60 as described elsewhere herein, such as by using the chiller 112 or radiator 64 to cool heat exchange fluid and pumping the fluid through a battery circuit 60. At this time, the battery packs 16a, 16b, the battery charge control module 42, and other components of the battery circuit thermal load 96 are cooled. The method 320 then returns to 321 to again determine whether the vehicle 12 is on or off plug.

In other examples, the steps of the method 320 can be performed in an order other than described. In still other examples, steps can be combined or further separated into further sub-steps.

In the above example method 320, different temperature limits are used to delay of cooling the battery packs 16a, 16b when the vehicle 12 is taken off plug. In another example method, a timer is used when the vehicle 12 is taken off plug to delay of cooling the battery packs 16a, 16b. The timer can be set to approximate an allowable rise in temperature for the battery packs 16a, 16b.

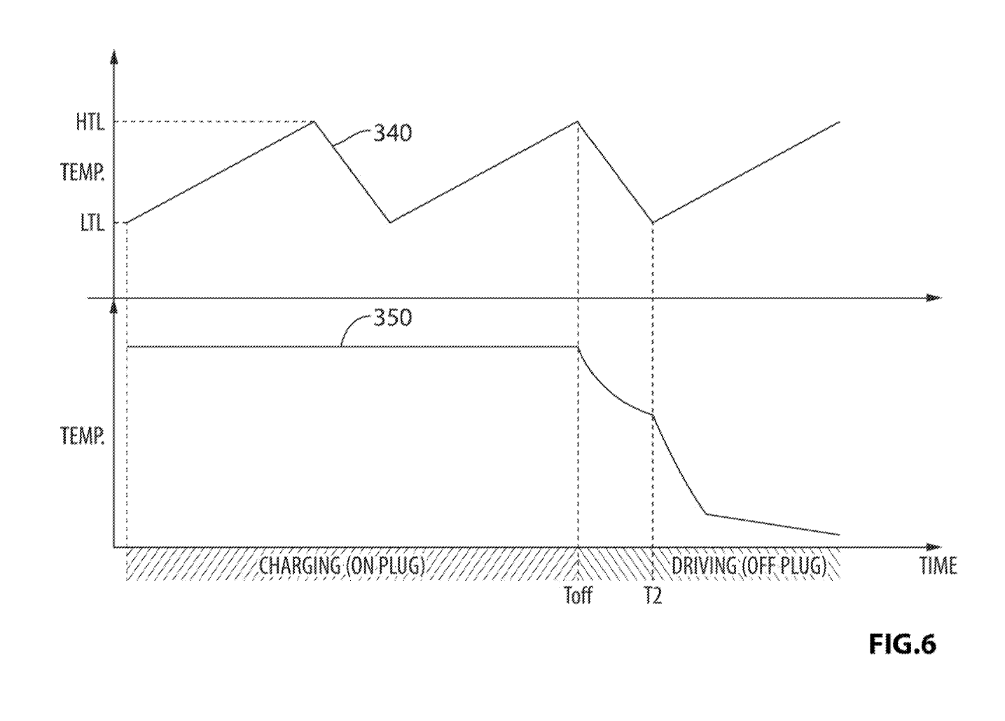

FIG. 6 shows a chart of cooling the battery packs 16a, 16b when taking the vehicle 12 from on-plug to off-plug, and when using the same temperature limit for the battery packs 16a, 16b for on-plug and off-plug.

A battery temperature curve 340 represents the temperature sensed by the battery circuit temperature sensor 116. A cabin temperature curve 350 represents the temperature of the passenger cabin 18, which, when cooling is of concern, can be measured at the evaporator 48. The curves 340, 350 have separate vertical temperature scales and share the same horizontal time scale.

While the vehicle 12 is on-plug, the battery temperature curve 340 rises as the battery circuit thermal load 96 heats due to waste heat from charging of the battery packs 16a, 16b, and then falls due to the controller 78 commanding cooling of the battery circuit 60. These rising and falling cycles occur between a lower temperature limit LTL (e.g., 36 degrees Celsius) and an upper temperature limit HTL (e.g., 38 degrees Celsius). At this time, since the vehicle 12 is not in use and the cabin temperature is not requested to be lowered, the cabin temperature curve 350 remains at ambient (e.g., 30 degrees Celsius).

Then, at time Toff, the vehicle 12 is taken off-plug and operated. At the same time, the cabin temperature is requested to be lowered via a cabin control. However, in this example, the battery temperature curve 340 is at or near the upper temperature limit HTL at time Toff. Therefore, both the evaporator 48 and chiller 112 demand cooling capacity from the compressor 30 to respectively cool the cabin 18 and the battery packs 16a, 16b. It is not until a later time T2 when the battery packs 16a, 16b have reached the lower temperature limit LTL that the evaporator 48 can be provided the full cooling capacity of the compressor 30. Hence, the cabin temperature curve 350 drops at a steeper rate when the battery packs 16a, 16b are no longer being cooled.

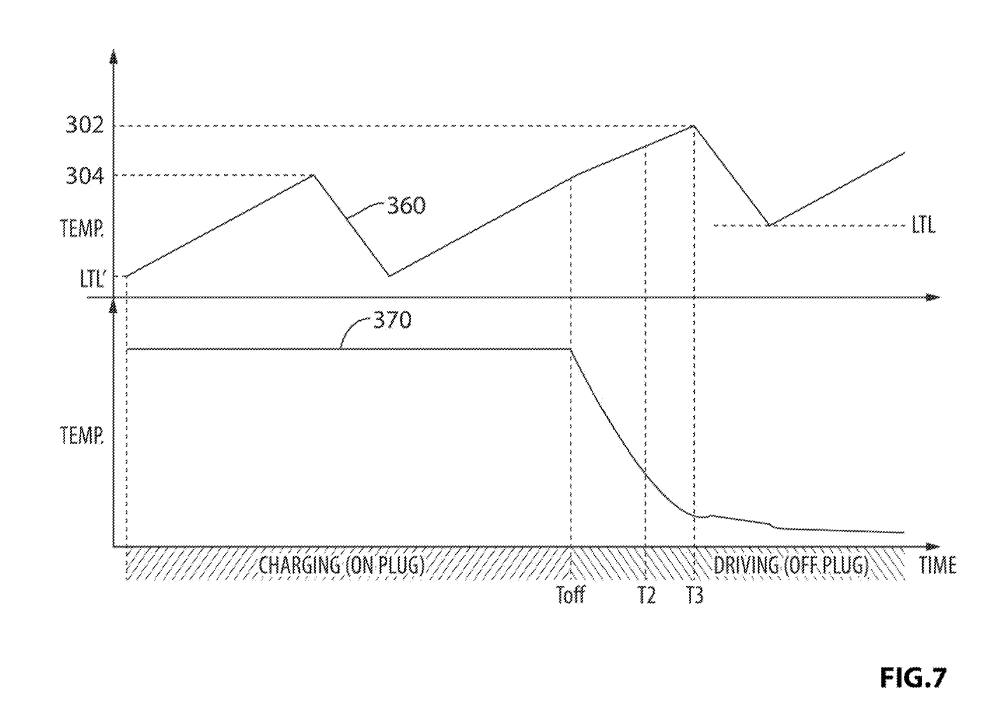

FIG. 7 shows a chart of cooling the battery packs 16a, 16b when taking the vehicle 12 from on-plug to off-plug, and when using different temperature limits for the battery packs 16a, 16b for on-plug and off-plug.

A battery temperature curve 360 represents the temperature sensed by the battery circuit temperature sensor 116. A cabin temperature curve 370 represents the temperature of the passenger cabin 18, which can be measured at the evaporator 48. The curves 360, 370 have separate vertical temperature scales and share the same horizontal time scale. The curves 360, 370 have the same scales as the respective curves 340, 350 of FIG. 6.

While the vehicle 12 is on-plug, the battery temperature curve 360 rises and falls similar to the curve 340. However, these rising and falling cycles occur between a lower temperature limit LTL′ (e.g., 35 degrees Celsius) and the second temperature limit 304 (e.g., 37 degrees Celsius) described above. At this time, since the vehicle 12 is not in use and the cabin temperature is not requested to be lowered, the cabin temperature curve 370 remains at ambient (e.g., 30 degrees Celsius).

Then, at time Toff, the vehicle 12 is taken off-plug and operated. At essentially the same time, the cabin temperature is requested to be lowered via a cabin control. However, at the same time, the limit selector 300 determines that the vehicle 12 has been taken off-plug and selects the first temperature limit 302 (e.g., 38 degrees Celsius) as the upper temperature limit for the battery packs 16a, 16b, and optionally further selects a corresponding low temperature limit LTL (e.g., 36 degrees Celsius). Accordingly, the temperature sensed by the battery circuit temperature sensor 16 is permitted to continue to rise, while the cabin 18 is cooled via the refrigerant system so that all of the refrigerant flow is used to cool the cabin 18. At time T3, the battery circuit temperature sensor 116 reports that the first temperature limit 302 has been reached, and so cooling of the battery packs 16a, 16b is begins. Thus, between times Toff and T3, the full cooling capacity of the compressor 30 can be provided to the evaporator 48 to meet the cooling demand of the cabin 18. For the sake of comparison, FIG. 7 also shows the time T2, at which it can be seen that the cabin temperature is lower than that of FIG. 6. Moreover, the curve 370 exhibits a lower cabin temperature between times Toff and T3 than the curve 350 does over the same time range, which illustrates an advantage of using the different temperature limits 302, 304, namely, increasing the effectiveness of cabin cooling.

As a separate consideration from the temperature ranges used for the battery circuit, different temperature limits when the vehicle 12 is on-plug and off-plug can also be referenced when cooling the motor circuit 56. Since the motor 14 is not operating and consequently not generating heat, when the vehicle 12 is on-plug, a higher temperature limit for the motor circuit 56 can be used to prevent unnecessary cooling of the motor circuit 56. This is particularly true in the event that the ambient air temperature is sufficiently low that the ambient air can bring the motor 14 (or more generally, the motor circuit thermal load) down to an acceptable temperature as the vehicle sits while on-plug.

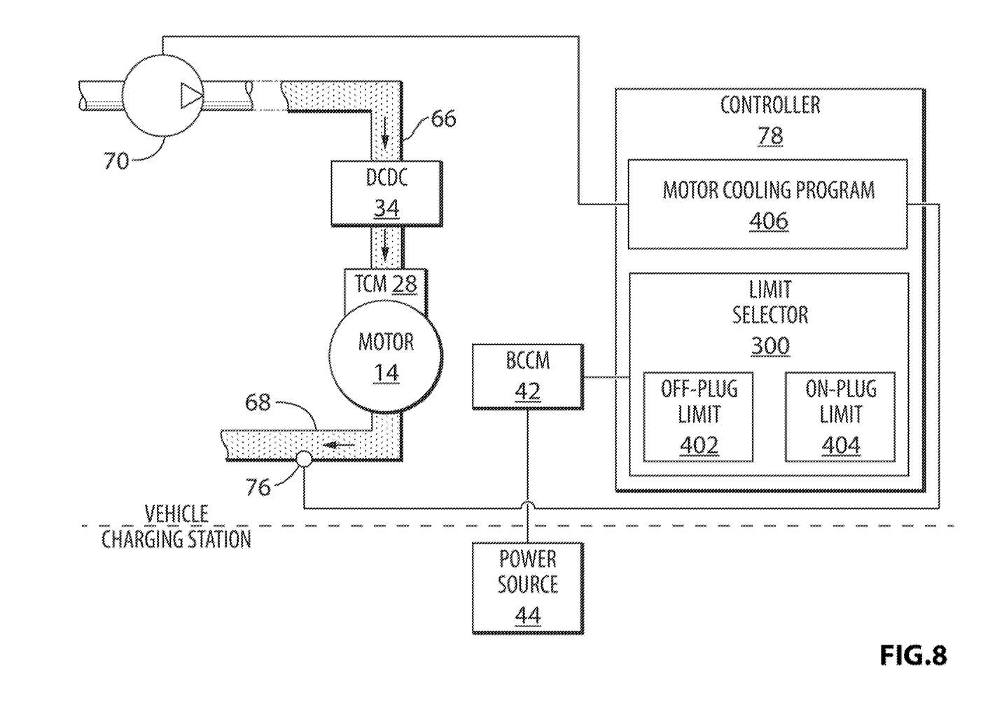

FIG. 8 shows a portion of the motor circuit 56 including the motor circuit pump 70, the DC/DC converter 34, the transmission control module 28, the motor 14, and the motor circuit temperature sensor 76. Heat exchange fluid flow is indicated by the arrows. Some components of the motor circuit 56 are omitted from this FIG. for clarity.

The controller 78 is configured to detect when the battery charge control module 42 is connected to the electrical source 44 to charge the battery packs 16a, 16b. In this example, the controller 78 includes the limit selector 300, discussed above, electrically connected to the battery charge control module 42. For clarity, not all components of the controller 78 are shown.

The limit selector 300 selects a temperature limit for the motor circuit temperature sensor 76 with reference to whether the battery charge control module 42 is detected as connected to the electrical source 44. The limit selector 300 selects a first motor circuit temperature limit (off-plug limit) 402 when detecting that the battery charge control module 42 is not connected to the electrical source 44 and selects a second motor circuit temperature (on-plug limit) 404 when detecting that the battery charge control module 42 is connected to the electrical source 44. Since the motor circuit 56 does not typically receive significant heat when the vehicle 12 is on-plug, the second motor circuit temperature limit 404 can be set higher than the first motor circuit temperature limit 402 thereby preventing unnecessary cooling of the motor circuit 56 at least some of which would have taken place passively as the vehicle sat on-plug anyway.

The first and second motor circuit temperature limits 402, 404 are upper limits, or maximum temperatures, that the controller 78 will allow at the motor circuit temperature sensor 76 before commanding the pump 70 to operate at a selected flow rate or speed to circulate fluid in the motor circuit 56 (and also optionally operating the radiator fan 144) to cool the circulated fluid. It will be noted that below these temperature limits 402 and 404, in some embodiments, the controller 78 will continue to operate the pump 70 (e.g. at about 40% duty cycle) when the vehicle is on plug. The third and fourth temperature limits 402, 404 can be the upper limits of temperature ranges that also have lower limits for the controller 78 to reference to stop cooling the motor circuit 56. In this example, the first temperature limit 402 is 50 degrees Celsius and is the upper limit of a temperature range that has a lower limit of 46 degrees Celsius, and the second temperature limit 404 is 70 degrees Celsius and is the upper limit of another temperature range that has a lower limit of 66 degrees Celsius. Thus, the second temperature limit is higher than the first temperature limit by 20 degrees Celsius. In other examples, the second temperature limit is higher than the first temperature limit by other amounts, such as 10 or 15 degrees Celsius. By reducing the amount of energy consumed while on-plug, the MPGe rating of the vehicle can be increased.

The controller 78 is configured to operate the motor circuit 56 to conform to the selected temperature limit 402 or 404 for the motor circuit temperature sensor 76. For example, the controller 78 can operate or refrain from operating any of the fluid-circuit components of the motor circuit 56, including the pump 70, the radiator bypass valve 75, and the radiator fan 144, to cool the motor circuit 56. A motor circuit cooling program 406 can be included in the controller 78 to ensure that the temperature of the motor circuit 56 as measured by the motor circuit temperature sensor 76 remains about below the temperature limit 402 or 404 selected by the limit selector 300.

The motor circuit cooling program 406 can be similar to the above-mentioned battery circuit cooling program 306. The motor circuit cooling program 406 can be part of a larger control program of the thermal management system 10. The motor circuit cooling program 406 can include logic of the limit selector 300. The motor circuit cooling program 406 has available as input the temperature sensed by the motor circuit temperature sensor 76, and can output a commanded speed for the motor circuit pump 70 and a commanded speed for the radiator fan 144. The motor circuit cooling program 406 can have additional inputs and outputs as well.

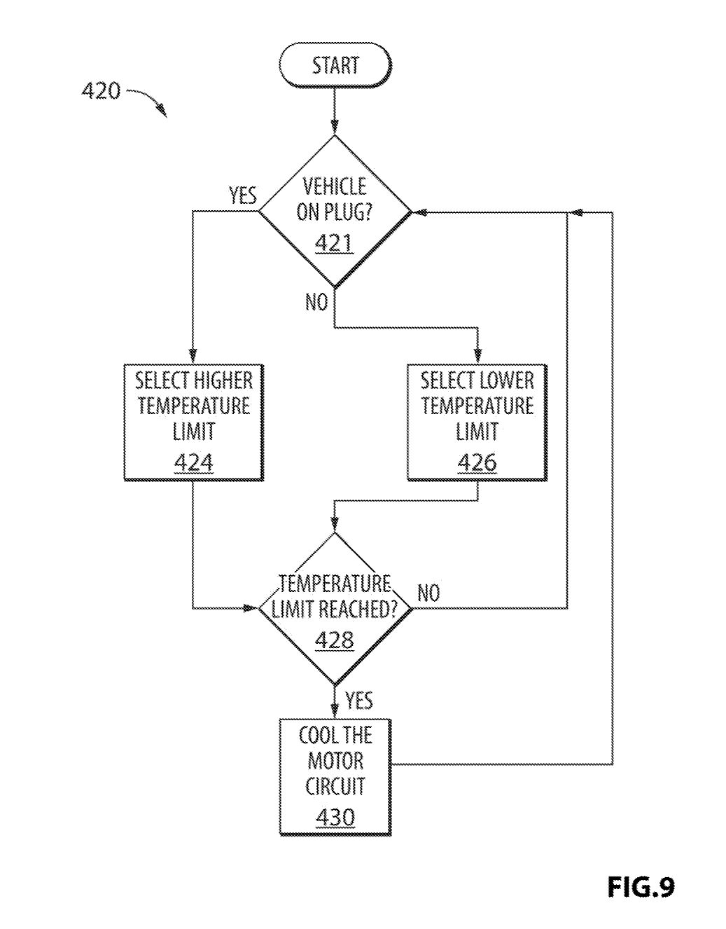

FIG. 9 shows a method 420 that can be performed by the controller 78, and specifically, by the limit selector 300 and the motor circuit cooling program 406. The method 420 can cool the motor circuit 56 according to two different temperature limits.

At 421, it is determined whether the vehicle 12 is on-plug. This can be determined by the limit selector 300.

When the vehicle 12 is on-plug, the fourth, higher temperature limit 404 is selected, at 424. Continuing the above example, the limit selector 300 selects 70 degrees Celsius as the temperature limit.

When the vehicle 12 is off-plug and operating such that the motor 14 and other components in the motor circuit 56 are generating heat, the third, lower temperature limit 402 is selected, at 426. Continuing the above example, the limit selector 300 selects 50 degrees Celsius as the temperature limit.

At 428, it is then determined whether the motor circuit 56 has reached the selected temperature limit. The motor circuit cooling program 406 compares the temperature of the motor circuit temperature sensor 76 to the selected temperature limit. If the selected temperature limit has not been reached, then the method 420 loops back to 421.

If the selected temperature limit has been reached, then the motor circuit is cooled, at 430. The motor circuit cooling program 406 operates the motor circuit 56 as described elsewhere herein, such as by operating the pump 70 and radiator fan 144 to cool heat exchange fluid and pump the fluid through a motor circuit 56. The motor circuit thermal load 61, namely, the motor 14, the transmission control module 28, and the DC/DC converter 34, is thus cooled. The method 420 then returns to 421 to again determine whether the vehicle 12 is on or off plug.

In other examples, the steps of the method 420 can be performed in an order other than described. In still other examples, one or more of the steps can be combined or further separated into sub-steps.

The different on-plug and off-plug temperature limits for the motor circuit 56 can be used in conjunction with the different on-plug and off-plug temperature limits for the battery circuit 60.

The controller 78 may have three battery circuit heating modes. The controller 78 determines a desired battery circuit thermal load temperature based on the particular situation, and determines whether a first heating condition is met, which is whether the desired battery pack temperature is higher than the actual battery pack temperature by a first selected calibrated amount. If the first heating condition is met, the controller 78 determines which of the three heating modes the controller 78 will operate in by determining which, if any, of the following second and third heating conditions are met. The second heating condition is whether the temperature sensed by the temperature sensor 76 is higher than the desired battery pack temperature by a second selected calibrated amount that may, for example, be related to the expected temperature drop of the fluid as the fluid flows from the temperature sensor 76 to the battery circuit thermal load 96. If the second condition is met, then the controller 78 operates in a first battery circuit heating mode, wherein the controller 78 positions the battery circuit valve 114 in the first position wherein flow is generated through the battery circuit 60 from the motor circuit 56 and the controller 78 turns the battery circuit heater 32 off.

The third heating condition is whether the temperature sensed by the temperature sensor 76 is lower than the desired battery pack temperature by at least a third selected calibrated amount, which may, for example, be related to the expected temperature rise associated with the battery circuit heater 108. If this third heating condition is met, then the controller 78 operates in a second battery circuit heating mode wherein the controller 78 positions the battery circuit valve 114 in the second position and turns on the pump 106 so that flow in the battery circuit 60 is isolated from flow in the motor circuit 56, and the controller 78 additionally turns on the battery circuit heater 108 to heat the flow in the battery circuit 60.

If neither the second or third conditions are met, (i.e. if the temperature sensed by the temperature sensor 76 is less than or equal to the desired battery pack temperature plus the second selected calibrated amount and the temperature sensed by the temperature sensor 76 is greater than or equal to the desired battery pack temperature minus the third selected calibrated amount, then the controller 78 operates in a third battery circuit heating mode wherein the controller 78 positions the battery circuit valve 114 in the first position so that flow in the battery circuit 60 is not isolated from flow in the motor circuit 56, and the controller 78 turns the battery circuit heater 108 on.

The default state for the controller 78 when battery circuit thermal load heating is initially requested may be to use the first battery circuit heating mode.

The thermal management system 10 will enter a battery circuit heating and cooling fault mode when the vehicle is in a fault state.

When the vehicle is off-plug, the controller 78 heats the battery circuit thermal load 96 using only the first battery circuit heating mode.

The default state for the controller 78 when the vehicle is turned on is to position the battery circuit valve 114 in the first position so as to not generate fluid flow through the battery circuit 60.

The controller 78 may operate using several other rules in addition to the above. For example the controller 78 may position the radiator bypass valve 75 in the first position to direct fluid flow through the radiator 64 if the temperature of the fluid sensed at sensor 76 is greater than the maximum acceptable temperature for the fluid plus a selected calibrated value and the cabin heating circuit valve 88 is in the first position and the battery circuit valve 114 is in the first position.

The controller 78 may also position the radiator bypass valve 75 in the first position to direct fluid flow through the radiator 64 if the temperature of the fluid sensed at sensor 76 has risen to be close to the maximum acceptable temperature for the fluid plus a selected calibrated value and the cabin heating circuit valve 88 is in the second position and the battery circuit valve 114 is in the second position.

In the event of an emergency battery shutdown, the controller 78 will shut off the compressor 30 and will turn on the cabin heating circuit heater 32 so as to bleed any residual voltage.

The temperature of the battery packs 16a and 16b may be maintained above their minimum required temperatures by the controller 78 through control of the refrigerant flow control valve 140 to the chiller 112. The temperature of the evaporator may be maintained above a selected temperature which is a target temperature minus a calibrated value, through opening and closing of the refrigerant flow control valve 138. The speed of the compressor 30 will be adjusted based on the state of the flow control valve 140 and of the flow control valve 138.

The controller 78 is programmed with the following high level objectives and strategies using the above described modes. The high level objectives include:

A. control the components related to heating and cooling of the battery circuit thermal load 96 to maintain the battery packs 16a and 16b and the battery charge control module 42 within the optimum temperature range during charging and vehicle operation;

B. maintain the motor 14, the transmission control system 28 and the DC/DC converter 34 at their optimum temperature ranges;

C. control the components related to heating and cooling the cabin 18 based on input from the climate control system; and

D. operate with a goal of maximizing vehicle range while meeting vehicle system requirements.

The controller 78 uses the following high level strategy on-plug:

When the vehicle is on-plug and is off, the controller 78 pre-conditions the battery packs 16a and 16b if required. Pre-conditioning entails bringing the battery packs 16a and 16b into a temperature range wherein the battery packs 16a and 16b are able to charge more quickly.

The controller 78 determines the amount of power available from the electrical source for temperature control of the battery packs 16a and 16b, which is used to determine the maximum permitted compressor speed, maximum fan speed or the battery pack heating requirements depending on whether the battery packs 16a and 16b require cooling or heating. A calibratible hysteresis band will enable the battery pack temperature control to occur in a cyclic manner if the battery pack temperatures go outside of the selected limits (which are shown in FIG. 3). If sufficient power is available from the electrical source, the battery packs 16a and 16b may be charged while simultaneously being conditioned (ie. while simultaneously being cooled or heated to remain within their selected temperature range). If the battery packs 16a and 16b reach their fully charged state, battery pack conditioning may continue, so as to bring the battery packs 16a and 16b to their selected temperature range for efficient operation.

When the vehicle is on-plug the battery circuit heater 108 may be used to bring the battery packs 16a and 16b up to a selected temperature range, as noted above. In one of the heating modes described above for the battery circuit 60, the battery circuit valve 114 is in the second position so that the flow in the battery circuit 60 is isolated from the flow in the motor circuit 56, and therefore the battery circuit heater 108 only has to heat the fluid in the battery circuit 60.

The cabin may be pre-conditioned (ie. heated or cooled while the vehicle is off) when the vehicle is on-plug and the state of charge of the battery packs 16a and 16b is greater than a selected value.

If the vehicle is started while on-plug, the controller 78 may continue to condition the battery packs 16a and 16b, to cool the motor circuit thermal load 61 and use of the HVAC system 46 for both heating and cooling the cabin 18 may be carried out.

When the vehicle is off-plug, battery pack heating may be achieved solely by using the heat in the fluid from the motor circuit (ie. without the need to activate the battery circuit heater 108). Thus, while the vehicle is off-plug and on and the battery packs 16a and 16b require heating, the battery circuit valve 114 may be in the first position so that the battery circuit 60 is not isolated from the motor circuit 56. Some flow may pass through the third battery circuit conduit 110 for flow balancing purposes, however the refrigerant flow to the chiller 112 is prevented while the battery packs 16a and 16b require heating. By using low-voltage battery circuit heaters instead of high-voltage heaters for the heaters 108, a weight-savings is achieved which thereby extends the range of the vehicle.

When the vehicle is off-plug, battery pack cooling may be achieved by isolating the battery circuit 60 from the motor circuit 56 by moving the battery circuit valve 114 to the second position and by opening the flow of refrigerant to the chiller 112 by moving the flow control valve 140 to the open position, and by running the compressor 30, as described above in one of the three cooling modes for the battery circuit 60.

It will be noted that the battery packs 16a and 16b may sometimes reach different temperatures during charging or vehicle operation. The controller 78 may at certain times request isolation of the battery circuit 60 from the motor circuit 56 and may operate the battery circuit pump 106 without operating the heater 108 or permitting refrigerant flow to the chiller 112. This will simply circulate fluid around the battery circuit 60 thereby balancing the temperatures between the battery packs 16a and 16b.

Reference is made to FIG. 3, which shows a graph of battery pack temperature vs. time to highlight several of the rules which the controller 78 (FIG. 2) follows. In situations where the vehicle is on-plug and the battery packs 16a and 16b are below a selected minimum charging temperature Tcmin (FIG. 3), the controller 78 will heat the battery packs 16a and 16b prior to charging them. Once the battery packs 16a and 16b reach the minimum charging temperature Tcmin, some of the power from the electrical source may be used to charge the battery packs 16a and 16b, and some of the power from the electrical source may continue to be used to heat them. When the battery packs 16a and 16b reach a minimum charge only temperature Tcomin, the controller 78 may stop using power from the electrical source to heat the battery packs 16a and 16b and may thus use all the power from the electrical source to charge them. Tcmin may be, for example, −35 degrees Celsius and Tcomin may be, for example, −10 degrees Celsius.

While charging, the controller 78 may precondition the battery packs 16a and 16b for operation of the vehicle. Thus, the controller 78 may bring the battery packs 16a and 16b to a desired minimum operating temperature Tomin while on-plug and during charging.

In situations where the vehicle is on-plug and the battery packs 16a and 16b are above a selected maximum charging temperature Tcmax, the controller 78 will cool the battery packs 16a and 16b prior to charging them. Once the battery packs 16a and 16b come down to the maximum charging temperature Tcmax power from the electrical source may be used to charge them, while some power may be required to operate the compressor 30 and other components in order to maintain the temperatures of the battery packs 16a and 16b below the temperature Tcmax. Tcmax may be, for example, 30 degrees Celsius.

The battery packs 16a and 16b may have a maximum operating temperature Tomax that is the same or higher than the maximum charging temperature Tcmax. As such, when the battery packs 16a and 16b are cooled sufficiently for charging, they are already pre-conditioned for operation. In situations where the maximum operating temperature Tomax is higher than the maximum charging temperature Tcmax, the temperatures of the battery packs 16a and 16b may be permitted during operation after charging to rise from the temperature Tcmax until they reach the temperature Tomax.

The maximum and minimum operating temperatures Tomax and Tomin define an example of an acceptable operating range for the battery packs 16a and 16b. In situations where the battery packs 16a and 16b are below minimum operating temperature or above their maximum operating temperature, the vehicle may still be used to some degree. Within selected first ranges shown at 150 and 152 (based on the nature of the battery packs 16a and 16b) above and below the noted operating range the vehicle may still be driven, but the power available will be somewhat limited. Within selected second ranges shown at 154 and 156 above and below the selected first ranges 150 and 152, the vehicle may still be driven in a limp home mode, but the power available will be more severely limited. Above and below the selected second ranges, the battery packs 16a and 16b cannot be used. The lower first range 150 may be between about 10 degrees Celsius and about −10 degrees Celsius and the upper first range 152 may be between about 35 degrees Celsius and about 45 degrees Celsius. The lower second range 154 may be between about −10 degrees Celsius and about −35 degrees Celsius. The upper second range may be between about 45 degrees Celsius and about 50 degrees Celsius.

It will be noted that the pumps 70, 86 and 106 are variable flow rate pumps. In this way they can be used to adjust the flow rates of the heat exchange fluid through the motor circuit 56, the cabin heating circuit 58 and the battery circuit 60. By controlling the flow rate generated by the pumps 70, 86 and 106, the amount of energy expended by the thermal management system 10 can be adjusted in relation to the level of criticality of the need to change the temperature in one or more of the thermal loads.

Additionally, the compressor 30 is also capable of variable speed control so as to meet the variable demands of the HVAC system 46 and the battery circuit 60.

Throughout this disclosure, the controller 78 is referred to as turning on devices (eg. the battery circuit heater 108, the chiller 112), turning off devices, or moving devices (eg. valve 88) between a first position and a second position. It will be noted that, in some situations, the device will already be in the position or the state desired by the controller 78, and so the controller 78 will not have to actually carry out any action on the device. For example, it may occur that the controller 78 determines that the chiller heater 108 needs to be turned on. However, the heater 108 may at that moment already be on based on a prior decision by the controller 78. In such a scenario, the controller 78 obviously does not actually ‘turn on’ the heater 108, even though such language is used throughout this disclosure. For the purposes of this disclosure and claims, the concepts of turning on, turning off and moving devices from one position to another are intended to include situations wherein the device is already in the state or position desired and no actual action is carried out by the controller on the device.

In this disclosure the use of an evaporator was described for cooling the air flow to the cabin 18 and a chiller was described for cooling the coolant in the battery circuit. It will be understood that the chiller is a first heat exchanger and may be replaced by any other suitable suitable type of heat exchanger, (e.g. a different type of heat exchanger that still uses refrigerant), and similarly the evaporator is a second heat exchanger and may be replaced by any other suitable suitable type of heat exchanger, (e.g. a different type of heat exchanger that still uses refrigerant).

While the above description constitutes a plurality of embodiments of the present disclosure, it will be appreciated that the present disclosure is susceptible to further modification and change without departing from the fair meaning of the accompanying claims.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A thermal management system for a vehicle, the vehicle including a traction motor and a battery pack, the thermal management system comprising:
a battery circuit for cooling a battery circuit thermal load including the battery pack;
a battery circuit temperature sensor positioned to sense a temperature relating to a temperature of the battery circuit thermal load; and
a controller configured to control the battery circuit to maintain the temperature sensed by the battery circuit temperature sensor below a first battery circuit temperature limit when the controller detects that the vehicle is not connected to an external electrical source, and to maintain the temperature sensed by the battery circuit temperature sensor below a second battery circuit temperature limit that is lower than the first battery circuit temperature limit when the controller detects that the vehicle is connected to the external electrical source.

2. A thermal management system as claimed in claim 1, further comprising a battery charge control module, that controls electrical current sent to the battery pack from the external electrical source, wherein the battery charge control module makes up part of the battery circuit thermal load.

3. A thermal management system as claimed in claim 1, wherein the vehicle includes a passenger cabin and the system further comprises:
a first heat exchanger positioned to cool fluid in the battery circuit;
a second heat exchanger positioned to cool an airflow leading to the passenger cabin; and
a compressor, positioned to compress refrigerant and to send the refrigerant through a refrigerant circuit leading to the first and second heat exchangers.

4. A thermal management system as claimed in claim 3, wherein the first heat exchanger is a chiller and the second heat exchanger is an evaporator.

5. A thermal management system as claimed in claim 3, wherein the first and second battery circuit temperature limits are selected based on at least one property of the second heat exchanger.

6. A thermal management system as claimed in claim 3, wherein the first and second battery circuit temperature limits are selected based at least in part on how quickly the second heat exchanger can reduce the temperature of the passenger cabin.

7. A thermal management system as claimed in claim 1, wherein the second battery circuit temperature limit is lower than the first temperature limit by between about 1 and about 3 degrees Celsius.

8. A thermal management system as claimed in claim 1, wherein the second battery circuit temperature limit is lower than the first temperature limit by about 1 degree Celsius.

9. A thermal management system as claimed in claim 1, further comprising:
a motor circuit for cooling a motor circuit thermal load including the traction motor, the motor circuit including a motor circuit pump; and
a motor circuit temperature sensor positioned to sense a temperature relating to a temperature of the motor circuit thermal load,
wherein the controller is further configured to control the motor circuit to maintain the temperature sensed by the motor circuit temperature sensor below a first motor circuit temperature limit when the controller detects that the vehicle is not connected to an external electrical source, and to maintain the temperature sensed by the motor circuit temperature sensor below a second motor circuit temperature limit that is higher than the first motor circuit temperature limit when the controller detects that the vehicle is connected to an external electrical source.

10. A thermal management system as claimed in cooling a battery circuit thermal load for a battery circuit of a vehicle, the vehicle including a traction motor and a battery pack that is at least part of the battery circuit thermal load, the method comprising:
cooling the battery circuit thermal load to maintain a temperature of the battery circuit thermal load below a first battery circuit temperature limit while not charging the battery pack using an external electrical source; and
cooling the battery circuit thermal load to maintain the temperature of the battery circuit thermal load below a second battery circuit temperature limit, the second battery circuit temperature limit being lower than the first battery circuit temperature limit while charging the battery pack using an external electrical source.

11. A method as claimed in claim 10, wherein the vehicle includes:
a passenger cabin;
a first heat exchanger positioned to cool fluid in the battery circuit;
a second heat exchanger positioned to cool an airflow leading to the passenger cabin; and
a compressor, positioned to compress refrigerant and to send the refrigerant through a refrigerant circuit leading to the first and second heat exchangers.

12. A method as claimed in claim 11, wherein the first heat exchanger is a chiller and the second heat exchanger is an evaporator.

13. A method as claimed in claim 11, wherein the first and second battery circuit temperature limits are selected based on at least one property of the second heat exchanger.

14. A method as claimed in claim 11, wherein the first and second battery circuit temperature limits are selected based at least in part on how quickly the second heat exchanger can reduce the temperature of the passenger cabin.

15. A method as claimed in claim 10, wherein the second battery circuit temperature limit is lower than the first temperature limit by between about 1 and about 3 degrees Celsius.

16. A method as claimed in claim 10, wherein the second battery circuit temperature limit is lower than the first temperature limit by about 1 degree Celsius.

17. A method as claimed in claim 10, further comprising:
cooling the motor circuit thermal load to maintain a temperature of the motor circuit thermal load below a first motor circuit temperature limit while not charging the battery pack using an external electrical source; and
cooling the motor circuit thermal load to maintain the temperature of the motor circuit thermal load below a second motor circuit temperature limit, the second motor circuit temperature limit being higher than the first motor circuit temperature limit while charging the battery pack using an external electrical source.

18. A thermal management system for an electric vehicle, the electric vehicle including a traction motor, a battery, a battery charge control module, and a passenger cabin, the thermal management system comprising:
a motor circuit for cooling a motor circuit thermal load including the traction motor;
a motor circuit temperature sensor positioned to sense a temperature of fluid in the motor circuit; and
a controller configured to control the motor circuit to maintain the temperature sensed by the motor circuit temperature sensor below a first motor circuit temperature limit when the controller detects that the vehicle is not connected to an external electrical source, and to maintain the temperature sensed by the motor circuit temperature sensor below a second motor circuit temperature limit that is higher than the first motor circuit temperature limit when the controller detects that the vehicle is connected to an external electrical source.
